(19) United States
(12) Patent Application Publication
(10) Pub. No.: US 2019/0059345 A1
(43) Pub. Date: Feb. 28, 2019

(54) Handle For A Fishing Pole

(71) Applicant: Ikaroa Outfitters, LLC, Holland, MI (US)

(72) Inventor: Michael Rian Flinsky, Holland, MI (US)

(21) Appl. No.: 15/683,872

(22) Filed: Aug. 23, 2017

(51) Int. Cl. A01K 87/08

(52) U.S. Cl. CPC A01K 87/08

(57) ABSTRACT

A handle for a fishing pole assembly having a fishing pole with a first end and a second end, and a reel attachable to the fishing pole. The handle has a pole coupling subassembly and a handle assembly. The pole coupling subassembly is structurally configured attach to the fishing pole between the first end and the second end thereof, while defining a pole axis. The handle assembly has a base attachment portion fixed to the pole coupling subassembly and a handle member pivotably coupled to the base attachment portion about an axis that is substantially transverse to the pole axis. A method is likewise disclosed.

### CROSS-REFERENCE TO RELATED APPLICATION

N/A

### BACKGROUND OF THE DISCLOSURE

### 1. Field of the Disclosure

The disclosure relates in general to fishing pole assemblies, and, more particularly, to a handle for a fishing pole that can be coupled to the fishing pole assembly.

### 2. Background Art

The use and operation of fishing pole assemblies is well known in the art. In many instances, especially when relatively larger fish are in the process of being caught, the need for leverage and the extensive use of arm muscles is well known. For example, when holding and reeling in a catch, the forearms are utilized extensively. Many amateurs lack the requisite the strength and stamina in their forearms that is necessary over the course of reeling in a catch. In some instances, as fatigue sets in, the user is no longer able to achieve the necessary grip on the fishing pole, or to exert the necessary leverage or rotation in the pulling of the pole.

While some handles have been developed which provide a user with an alternative to grasping of the fishing pole, such handles suffer from drawbacks. In some instances, the handles rely on poor placement, coupling and/or ergonomics. In other instances, the handles lack the necessary structure to achieve desirable results for a wide variety of users.

### SUMMARY OF THE DISCLOSURE

The disclosure is directed to a handle for a fishing pole assembly. The fishing pole assembly includes a fishing pole with a first end and a second end, and a reel attachable to the fishing pole between the first and second end thereof. The handle comprises a pole coupling subassembly and a handle assembly. The pole coupling subassembly is structurally configured attach to the fishing pole between the first end and the second end thereof. The pole coupling subassembly defines a pole axis. The handle assembly has a base attachment portion fixed to the pole coupling subassembly and a handle member pivotably coupled to the base attachment portion about an axis that is substantially transverse to the pole axis.

In some configurations, the pole coupling subassembly further comprises a pole receiver defining a channel, and a clamp member defining an inner channel. Cooperatively, the channel and the inner channel define a passage that corresponds to the fishing pole. The pole receiver includes a clamp coupling and the clamp member includes a receiver coupling matingly engage each other, structurally configured to encircle the fishing pole.

In some configurations, the pole receiver and the clamp member are secured to each other through fasteners.

In some configurations, the pole receiver further includes a reel coupling. The reel coupling includes a plurality of openings, structurally configured to matingly engage corresponding openings on a reel, and structurally configured to receive fasteners extendable therethrough, to in turn, sandwich a fishing pole between therebetween.

In some configurations, the base attachment portion is fixed to the pole receiver proximate a first end thereof.

In some configurations, the base attachment portion comprises a first side tab having a first side pivot; and a second side tab having a second side pivot. The second side tab is spaced apart from the first side tab. The handle member comprises a grasping portion defining a passage therethrough. The handle member includes a mating pivot cooperatively alignable with the pivot to define the axis, and positionable between the first side tab and the second side tab.

In some configurations, the base attachment portion and the handle member comprise a monolithic member.

In some configurations, a pivot axle is extendable through the first side pivot, the second side pivot and the mating pivot.

In some configurations, the handle includes a pivot limiting structure to limit the forward and rearward pivoting of the handle member relative to the base attachment portion.

In some configurations, the pivot limiting structure further comprises a forward and a rearward limiting subassembly. The forward limiting subassembly includes a forward base wall formed on the base attachment portion and a forward handle wall formed on the handle member, whereupon engagement therebetween precludes further forward pivoting. The rearward limiting subassembly includes a rearward base wall formed on the base attachment portion and a rearward handle wall formed on the handle member, whereupon engagement therebetween precludes further rearward pivoting.

In some configurations, the grasping portion further defines a lower passage and an upper passage. The upper passage extends from the lower passage and includes a first side grasping region and a second side grasping region opposite the first side grasping region. An upper transverse grasping region extends between the first and second side grasping regions.

In some configurations, the lower region defines a lower passage which is narrower than the upper passage defined by the first and second side grasping regions and the upper transverse grasping region.

In some configurations, the handle member is symmetrical about the pole axis.

In some configurations, the first and second side grasping regions are substantially parallel to the pole axis.

In some configurations, the upper transverse grasping region is substantially perpendicular to the pole axis.

In another aspect of the disclosure, the disclosure is directed to a combined fishing pole assembly and handle. The fishing pole assembly comprises a fishing pole and a reel. The fishing pole has a first end and a second end. The reel is attachable to the fishing pole between the first and second end thereof. The reel is structurally configured to receive a fishing line. The handle comprises a pole coupling subassembly and a handle assembly. The pole coupling subassembly is structurally configured attach to the fishing pole between the first end and the second end thereof. The pole coupling subassembly defines a pole axis as well. The handle assembly has a base attachment portion fixed to the pole coupling subassembly and a handle member pivotably coupled to the base attachment portion about an axis that is substantially transverse to the pole axis.

In some configurations, the pole coupling assembly is coupled to the reel and clamped to the fishing pole.

In some configurations, the handle member defines a grasping portion that defines a passageway structurally configured to receive the fishing line therethrough and that is spaced apart from the fishing line when in an articulated configuration.

In yet another aspect of the disclosure, the disclosure is directed to a method of installing a handle onto a fishing pole assembly comprising the steps of: providing a fishing pole assembly including a fishing pole, a reel attached to the fishing pole between the first and second end thereof, the reel structurally configured to receive and retain a fishing line; providing a pole coupling subassembly defining a pole axis; positioning the fishing pole along the pole axis; attaching the pole coupling subassembly to at least one of the fishing pole and the reel; and pivotally attaching a handle member to the pole coupling subassembly, the handle structurally configured to pivot about a transverse axis that is substantially perpendicular to the pole axis.

In some configurations, the step of pivotally attaching further comprises the step of limiting the pivoting of the handle member between a fully articulated configuration and a collapsed configuration.

### BRIEF DESCRIPTION OF THE DRAWINGS

The disclosure will now be described with reference to the drawings wherein:

FIG. 1 of the drawings is a back perspective view of the handle for a fishing pole of the present disclosure;

FIG. 2 of the drawings is a front perspective view of the handle for a fishing pole of the present disclosure;

FIG. 3 of the drawings is a back elevation view of the base attachment portion of the handle assembly;

FIG. 4 of the drawings is a perspective view of the handle assembly;

FIG. 5 of the drawings is a bottom perspective view of the clamp member of the pole coupling assembly detailing the inner channels and structure therein;

FIG. 6 of the drawings is a top perspective view of the clamp member of the pole coupling assembly;

FIG. 7 of the drawings is a front elevation view of the handle member showing, in particular, the grasping portion thereof;

FIG. 8 of the drawings is a perspective view of the handle member showing, in particular, the base coupling portion;

FIG. 9 of the drawings is bottom perspective view of the fishing pole assembly showing coupling to the fishing pole assembly;

FIG. 10 of the drawings is a perspective view of the fishing pole assembly showing, in particular, the handle for a fishing pole coupled thereto and in the collapsed orientation;

FIG. 11 of the drawings is a perspective view of the fishing pole assembly showing, in particular, the handle for a fishing pole coupled thereto and in the fully articulated configuration;

FIG. 12 of the drawings is a perspective view of the handle for a fishing pole in operation showing, in particular, the grasping of the upper transverse grasping region; and

FIG. 13 of the drawings is a perspective view of the handle for a fishing pole in operation showing, in particular, grasping of one of the side grasping regions.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

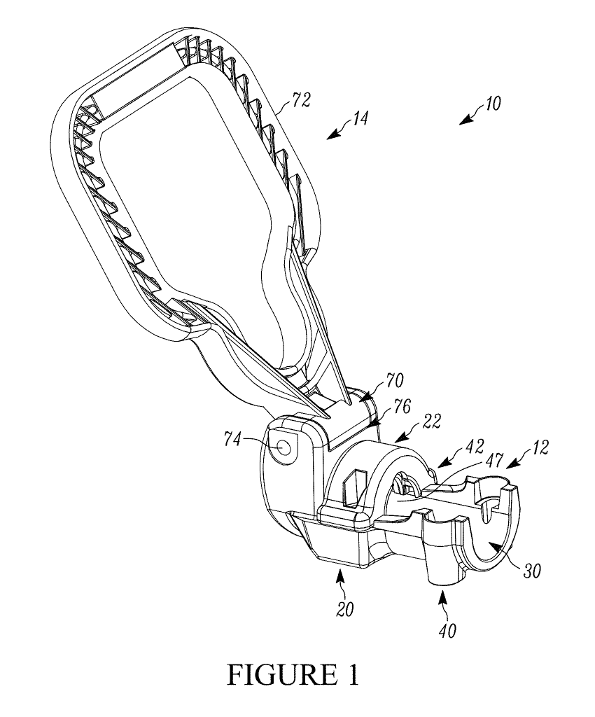

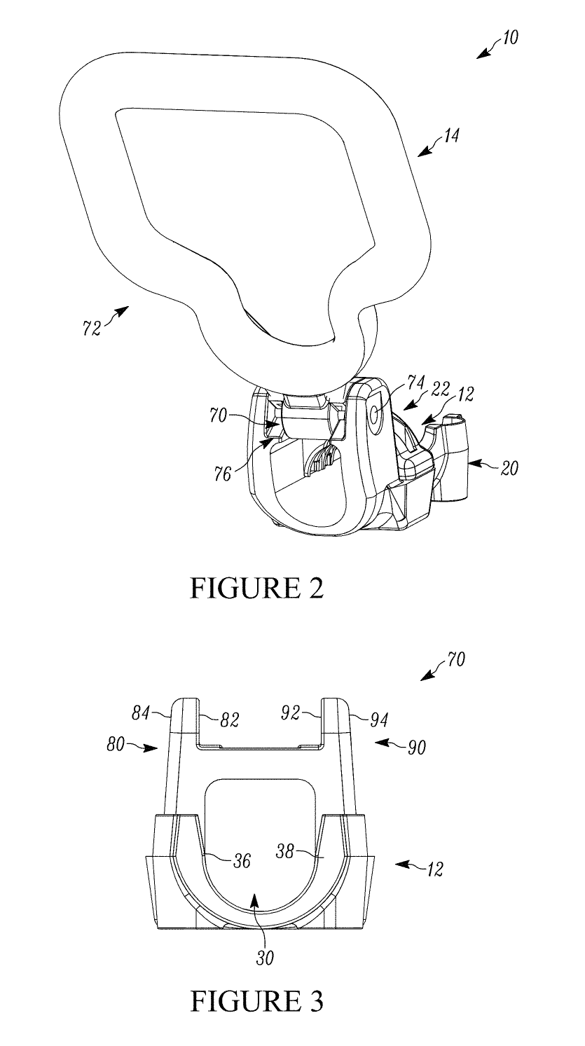

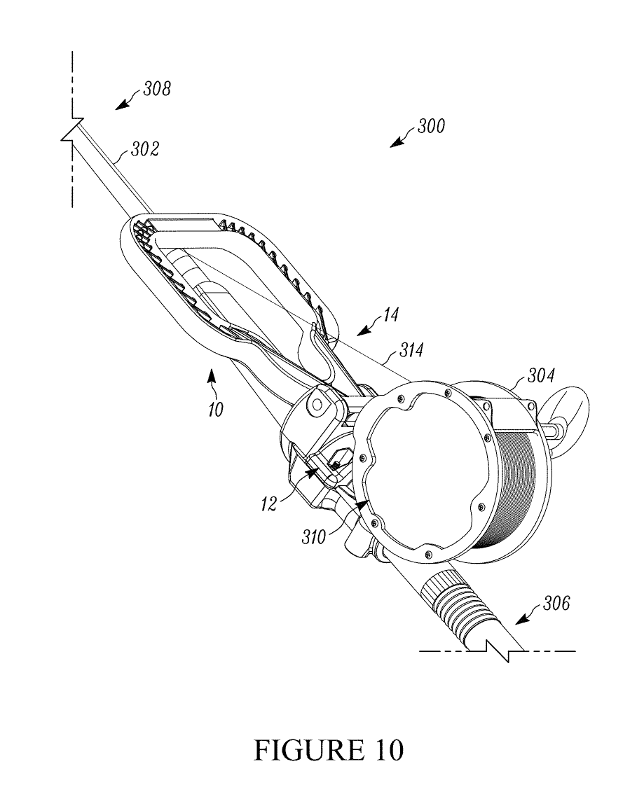

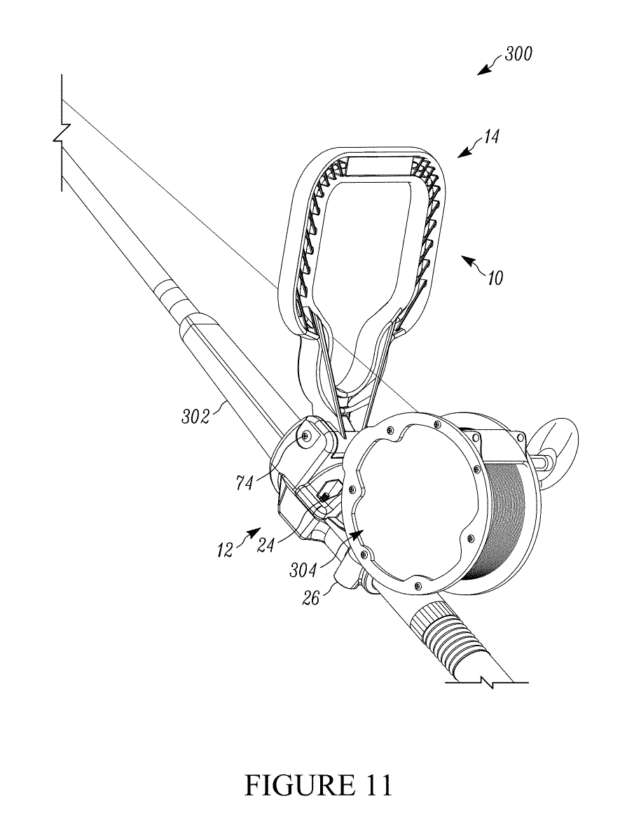

Referring now to the drawings, and in particular to FIGS. 1 and 2, a handle 10 for a fishing pole is shown. The handle 10 comprises a pole coupling subassembly 12 and handle assembly 14. With reference to FIGS. 10 through 13, the handle 10 is configured for use in association with a fishing pole assembly 300. The fishing pole assembly includes fishing pole 302 and reel 304 which is coupled to the fishing pole 302. It will be understood that the handle, and various portions thereof may be formed from any number of different materials, including but not limited to polymers, composites, metals (including alloys thereof) alone or in combination, and without limitation.

The pole coupling subassembly 12, as shown in FIGS. 3 through 6, comprises a pole receiver 20 and clamp member 22. The pole receiver 20 includes channel 30, reel coupling 40, and clamp coupling 42. The channel 30 is an open cavity defined by pole receiver 20, that is defined by front end 32, back end 34, first side 36, and second side 38. The channel spans from front end 32 to back end 34 which is opposite the front end. Likewise, the channel spans between first side 36 and second side 38 which is opposite the first side. In the configuration shown, the length of the channel between the front end and the back end is of a dimension that is larger than the width defined between the first side and the second side. A pole axis 45 is defined by the channel. Dimensioning between the front end 32 and back end 34 are not necessarily equal and vary in contemplated configurations. Front end 32 is closest to the attachment of the handle subassembly 14 with first side 36 and second side 38 situated substantially perpendicular in reference to the front end 32 and back end 34. In the configuration shown, channel 30, as shown in FIG. 3, comprises a partial cylindric configuration of a size that it is substantially equal to the shape and dimensions of a corresponding portion of fishing pole 302 which can be coupled thereto. The contemplated configurations of the cavity may have variable dimensions and lengths, including, but not limited to, the length separation between the first end 32 and back end 34, the width separation between first side 36 and second side 38, and cavity shape of channel 30, to, for example, accommodate fishing poles of varying dimensions and the like.

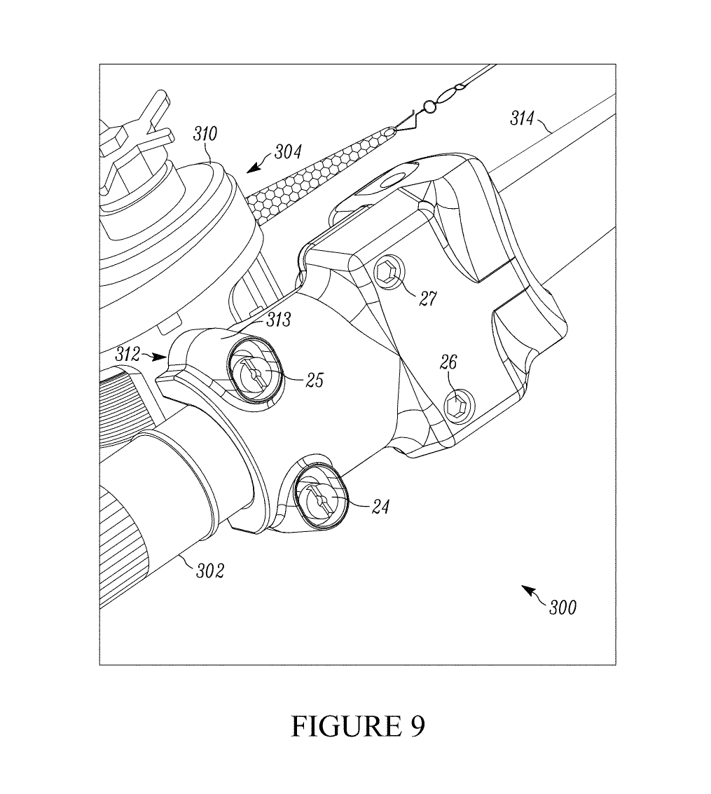

Reel coupling 40 further comprises opening 41 and opening 43. Both Opening 41 and opening 43 extend through the pole receiver in such a way that openings 41 is substantially parallel to opening 43 and on opposite sides of the channel 30. That is, opening 41 is on the first side of channel 30 while, correspondingly, the opening 43 is on the second side of channel 30. Further, opening 41 and opening 43 are both substantially perpendicular in reference to channel 30, in the configuration shown. As will be understood, and with reference to FIG. 9, reel fasteners 24, 25 extend therethrough and interface with openings or corresponding fasteners in the reel 304. In contemplated configurations, openings 41 and 43 of reel opening 40 are of variable size and shape, dependent upon the reel fastener 24 and reel fastener 25 which are configured to extend therethrough and dependent on the configuration of corresponding openings on the reel to which the fasteners are coupled. In place of fasteners and openings, the reel coupling may comprise a structure that has an interference fit with the reel, or a snap fit with the reel or fasteners associated with the reel. The disclosure is not limited to openings defining the reel coupling, and fasteners extending therethrough.

Clamp coupling 42 further comprises opening 47 and opening 49. Both Opening 47 and opening 49 extend through the pole receiver on opposite sides of the channel. That is, opening 47 is on one side of the channel with the opening 49 being on the other side of the channel. In the configuration shown, opening 47 is substantially parallel to opening 49 and positioned so as to correspond to each other. Further, opening 47 and opening 49 are both substantially perpendicular in reference to channel 30 in the configuration shown. In contemplated configurations, openings 47 and 49 of clamp opening 42 may be of variable size and shape, dependent upon the clamp fastener 26 and clamp fastener 27.

As set forth above, in the configuration shown, the reel coupling is positioned between the front end and the back end of the channel of the pole receiver, with the openings thereof being on opposite sides. Similarly, the clamp coupling is positioned between the front end and the back end of the channel of the pole receiver, with the openings thereof being on opposite sides. In the configuration shown, the reel coupling is positioned between the clam coupling and the back end of the channel with the clamp coupling being positioned between the first end and the reel coupling such that from front end to back end, the clamp coupling is first encountered followed by the reel coupling. In other configurations, it is contemplated that the relationship between the ends and the coupling may be different.

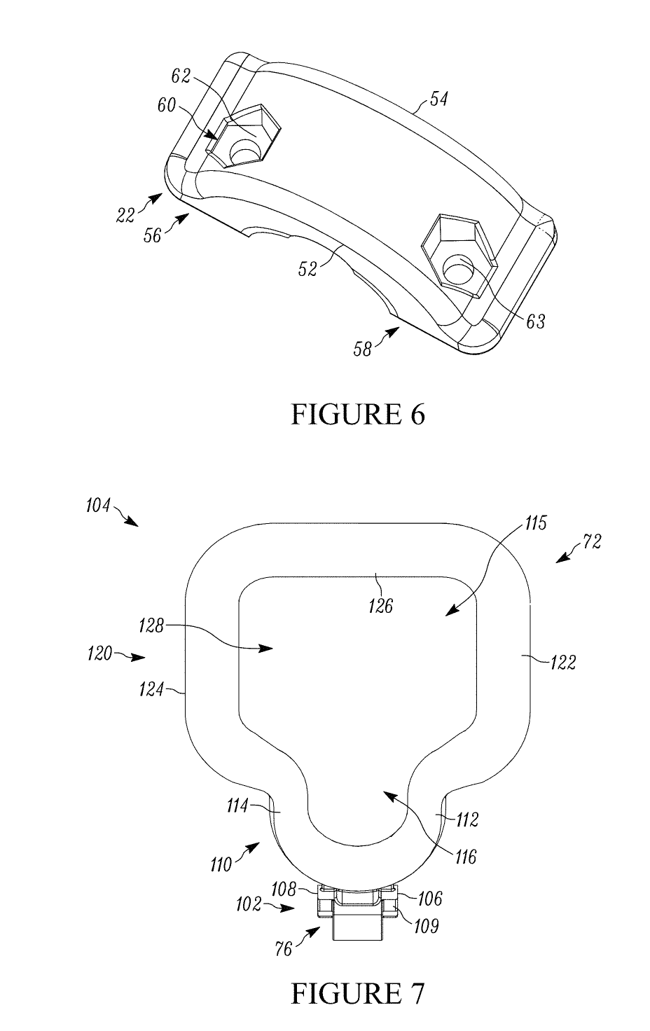

Clamp member 22, as shown in FIGS. 5 and 6, comprises by inner channel 50 and receiver coupling 60. The inner channel 50 is defined by front 52, back 54, first side 56, second side 58, and gripping ribs 59. The interior channel 50, in the configuration shown, generally complements the channel 30. The front is opposite the back and the first side is opposite the second side. The gripping ribs are substantially transverse about the interior of the inner channel 50 and extend from first side to the second side. The number and size of gripping ribs 59 are variable and subject to change in contemplated configurations. The gripping ribs, in the configuration shown, generally protrude from the inner channel. In contemplated configurations, the inner channel 50 may be of varying shapes and dimensions to substantially correspond to the dimensions of the fishing pole 302.

The receiver coupling 60 comprises the opening 62 and opening 63. Opening 62 is on the first side 56 of the clamp member 22 and opening 63 is on the second side 58 of the clamp member 22. Both openings 62, 63 are substantially parallel in reference to one another, in the configuration shown, so as to substantially match the openings 47, 49 of the clamp coupling. Both openings 62 63 extend throughout the clamp member 22 from the top of the clamp member 22 to the bottom. In the exemplary figure, the receiver coupling allows for clamp fastener 26 and clamp fastener 27 to attach through opening 62 and opening 63 in such a way they are able to substantially couple to the clamp couplings 42 of the pole receiver 20. In other configurations, the receiver coupling may comprise a snap fit arrangement or other structure with which to engage the clamp coupling of the pole receiver.

Where fasteners are utilized for cooperative engagement with the reel coupling and the receiver coupling, fasteners such as clamp fastener 26, clamp fastener 27, reel fastener 24, and reel fastener 25 all of which are shown in FIG. 9 can be utilized. Exemplarily illustrated, the fasteners are comprise threaded members that extend through opening 41, opening 43, opening 47 and opening 49. Clamp fastener 26 is axially aligned with clamp coupling 42 opening 47 and receiver coupling 60 opening 62. Clamp fastener 27 is axially aligned with clamp coupling 42 opening 49 and receiver coupling 60 opening 63. Fasteners are sized substantially to force coupling between the pole coupling subassembly 12. That is, the clamp fastener 26 and clamp fastener 27 are secured in such a way that the pole receiver 20 and the clamp member 22 are mated along their surfaces and sufficiently coupled. Secured in such a way, the pole receiver 20 and the clamp member 22 create channel 30 and define the pole axis 45. The Clamp fastener 26 and clamp fastener 27 are positioned through the top of the pole coupling subassembly 12 and is axially placed until such time the pole receiver 20 is significantly coupled to the clamp member 22. It is to be understood the figure presented is exemplary of the placement of the clamp fastener 26 and clamp fastener 27 within the clamp coupling 42 and receiver coupling 60. In contemplated configurations, the placements of the clamp fastener 26 and clamp fastener 27 may be applied from bottom to top or other variable insertions.

Reel fastener 24 and reel fastener 25 are axially aligned with the reel coupling 40 through openings 41 and opening 43. The reel fastener 24 axially aligns with reel coupling 40 opening 41 and coupling clamp 312 fastener opening 313 of the reel 304. The reel fastener 25 axially aligns with reel coupling 40 opening 43 and the coupling clamp fastener opening of the reel 304. It is to be understood the reel fasteners are substantially parallel in reference to one another and of such length to allow sufficient coupling between the reel 304 of the fishing pole assembly 300 and the reel coupling 40 of pole coupling subassembly 12. The reel fastener 24 and reel fastener 25 are placed from beneath the pole coupling subassembly 12.

Further, the length and dimensions of fasteners listed are variable and dependent upon the reel 304, pole receiver 20, and clamp member 22. In contemplated configurations, the fasteners will be adjusted in such a way that coupling of the previously mentioned parts is continuous. Fasteners may be, but not limited to, bolts, screws, or other such axially designed coupling members.

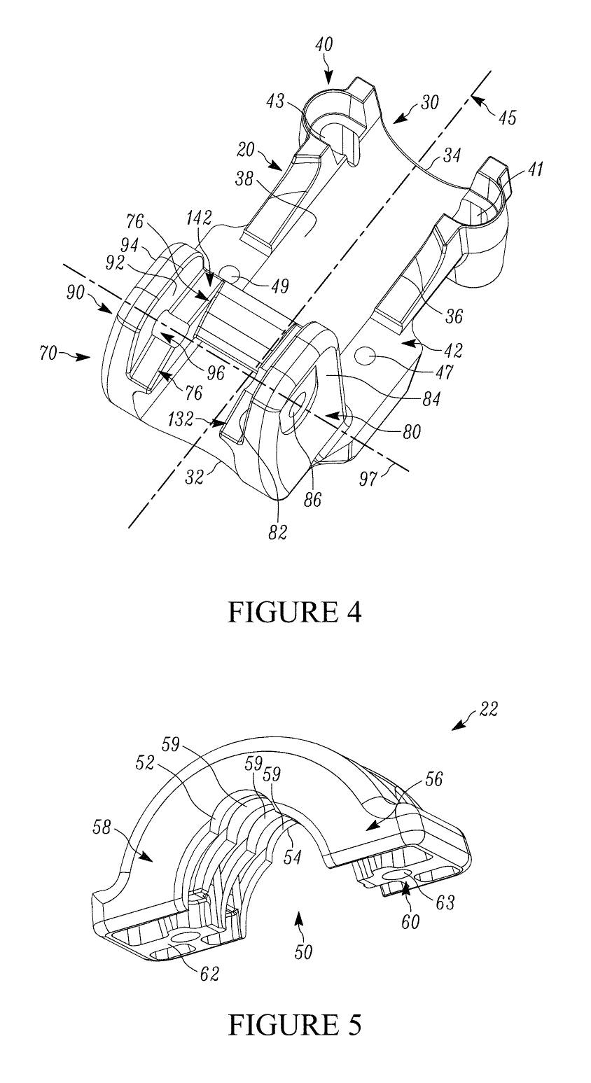

As shown in FIGS. 4, 7, and 8, the handle assembly 14 comprises base attachment portion 70, handle member 72, pivot axle 74 (FIGS. 1 and 2), and pivot limiting structure 76. The base attachment portion 70, in the configuration shown, is attached to and integrally formed with the pole receiver, at a front end of the channel of the pole coupling subassembly 12. The base attachment portion is located closest to the front of the pole coupling subassembly 12. It will be understood that the position upon the pole coupling subassembly may be varied in various configurations of the handle for a fishing pole 10, and in some configurations, the structure may or may not be integrally formed with the pole receiver. In particular, in the configuration shown, the structures are molded together, whereas in other structures they may comprise separate structures which may be coupled together, for example.

Base attachment portion 70 further comprises first side tab 80 and second side tab 90. The first side tab 80 is opposite the second side tab 90 in a spaced apart configuration by a distance variable and dependent upon the contemplated configuration. The first side tab 80 further comprises inner surface 82, outer surface 84, and pivot opening 86. Further, the second side tab 90 comprises inner surface 92, outer surface 94, and pivot opening 96. The inner surface 82 and inner surface 92 face each other and are spaced apart from each other. The outer surfaces are on opposing sides from the inner surfaces and face outwardly to either side. In the configuration shown, the outer sides substantially correspond to the first and second side of the channel 30, although variations are contemplated. Pivot opening 86 extends through the first side tab 80 and pivot opening extends through the second side tab 90. The pivot opening 86 in the configuration shown is substantially perpendicular to both inner surface 82 and outer surface 84 of the first side tab 80. Further, the pivot opening 96 is substantially perpendicular to both inner surface 92 and outer surface 94 of the second side tab 90. The pivot openings are substantially equal and axially aligned to define transverse axis 97. The transverse axis 97 is substantially perpendicular to pole axis 45 in planar relation to one another. In other words, transverse axis 97 runs across the fishing pole 302 while the pole axis 45 extends along the length of the handle of the fishing pole 302. The height separation between the transverse axis 97 and pole axis 45 is variable and subject to be altered depending on the contemplated configurations. In the configuration shown, the transverse axis 97 extends above the axis 45 so as to be above the position of the fishing pole.

A pivot axle can extend through the pivot 86, 96 and along the transverse axis 97 defining the same. It will be understood that in other configurations, the pivot 86 and 96 may comprise tab and slot or other mating configurations which allow for coupled pivoting therebetween.

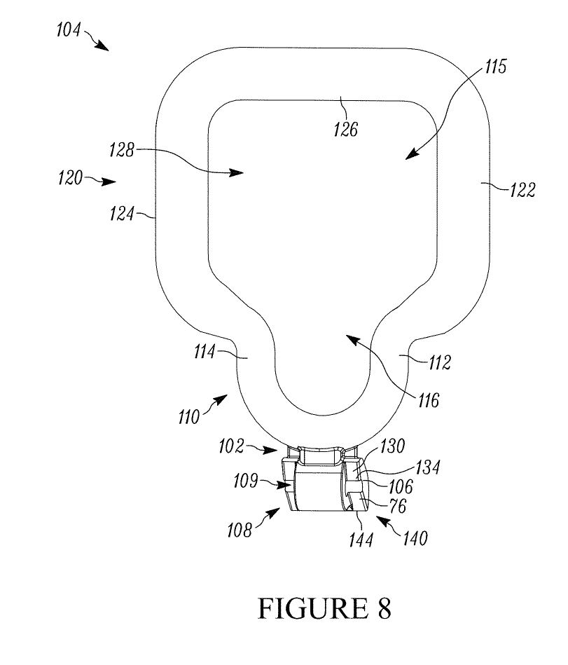

The handle member 72 of the handle assembly 14 comprises base coupling portion 102 and grasping portion 104. The grasping portion 104 extends away from the base coupling portions, as is shown in in FIGS. 7 and 8. The two portions are associated in such a way, in the configuration shown, that the movement of one relates to substantially equal movement in the other, allowing them to be seen as a singular part when in action. In the configuration shown, the two components are integrally molded as a single member. In other configurations, there may be relative movement between the two components.

The base coupling portion 102 further comprises first side 106, second side 108, and mating pivot 109. The first side 106 and second side 108 are opposite one another. have a separation distance variable and dependent upon the contemplated configurations. The separation between first side 106 and second side 108 defines a body of the base coupling portion to be in substantial correspondence with the area between the first side tab 80 and second side tab 90 of the base attachment portion so as to fit therebetween when assembled. The mating pivot 109 is an opening through first side 106 and second side 108 of the base coupling portion. As will be explained below, the mating pivot opening is to be axially aligned with the pivot opening 86 of the first side tab 80 and the pivot opening 96 of the second side tab. Further, the axial alignment of pivot opening 86, pivot opening 96, and mating pivot 109 collectively the transverse axis 97 between the baste attachment portion of the handle assembly and the base coupling portion 102 of the handle member 72, through which the pivot axle 74 is directed. As set forth above, in other configurations, the mating pivot can cooperatively engage with the pivot 86, 96 in another manner (bump and detent, ball and socket, among others) so as to allow pivoting about a defined transverse axis 97.

The grasping portion 104 comprises lower region 110 and upper region 120. The upper region 120 extends from the lower region 110. The lower region 110 defines lower passage 116 and upper region 120 defines upper passage 128, and, collectively these define passage 115 within the center of the grasping portion 104. The passage essentially comprises an empty space that allows objects to pass through the handle member 72 therethrough.

The lower region further comprises first side 112 and second side 114. The first side 112 and second side 114 are opposite one another and extend from the base coupling portion 102. The first side 112 extends from and is mated to the first side 106 of the base coupling portion 102. The second side 114 extends from and is mated to the second side 108 of the base coupling portion 102. Because of the curvature shape of the first side 112 and second side 114, the lower passage 116 defines the empty space between the two. The configuration of the lower passage 116 is exemplary shown in FIG. 7 but is variable and subject to change in contemplated configurations. It will be understood that, in operation, as will be described below, in the articulated configuration, the fishing line 314 passes through the lower passage 116.

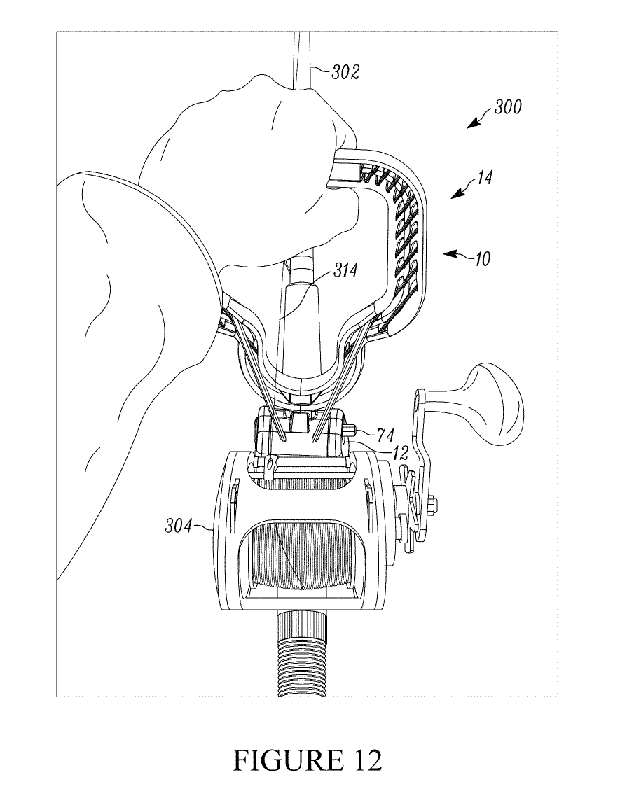

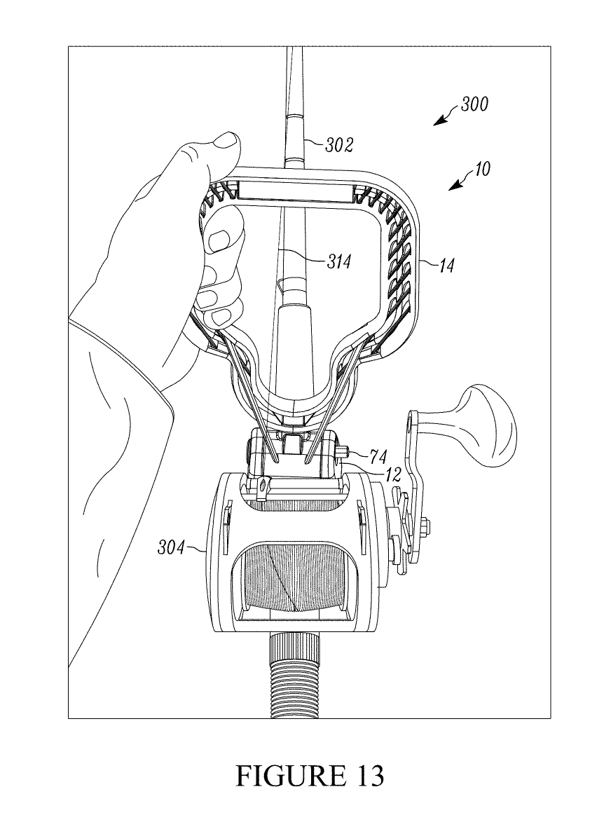

The upper region 120 comprises first side grasping portion 122, second side grasping portion 124 and upper transverse grasping region 126. The first side grasping portion 122 and second side grasping portion 124 are opposite one another, connected by the upper transverse grasping portion 126 which traverses between the two. The first side grasping portion 122 and second side grasping portion 124 are substantially parallel in reference to one another in the configuration shown, both being perpendicular and substantially connected to the upper transverse grasping portion 126. As is shown in FIGS. 12 and 13, a user may grasp the grasping portion in various manners. The upper passage 128 is defined by the region beneath the upper transverse grasping region 126 and between the first side grasping portion 122 and second side grasping portion 124. The upper passage 128 and lower passage 116 are empty spaces that together define passage 115. The depth, width, and length of passage 115 is variable and dependent upon the sizing of grasping portion 104. The size is subject to change in contemplated configurations. In the configuration shown, the upper region is relatively larger as compared to the lower region. Additionally, in the configuration shown, the handle member is substantially symmetrical about an axis that substantially corresponds to the pole axis 45 when installed. It will further be understood that the grasping portion is suitable for both right handed users and left handed users due (which may depend on the reel handle position), at least in part to, the substantially symmetrical configuration.

The pivot limiting structure 76 comprises forward limiting subassembly 130 and rearward limiting subassembly 140, which are configured to limit the forward pivoting and the rearward pivoting (i.e., the operable range) of the handle member relative to the clamp member to, in turn, define the folded orientation at one extreme and the fully articulated orientation at the other extreme.

More particularly, the forward limiting subassembly 130 comprises forward base wall 132 and forward handle wall 134. The forward base wall 132 is mounted on the base attachment portion outboard of the transverse axis 97. The forward handle wall 134 is mounted on the base coupling portion of the handle member. When rotated toward the folded orientation (i.e., in the assembled configuration, directed toward the front of the pole), the forward base wall and the forward handle wall reach abutment and further pivoting is precluded.

The rearward limiting subassembly 140 comprises rearward base wall 142 (FIG. 4) and rearward handle wall 144 (FIG. 8). The rearward base wall 142 is mounted on the base attachment portion 70 outboard of the transverse axis 97. The rearward handle wall 144 is mounted on the base coupling portion 102 of the handle member 72. When rotated towards an fully articulated orientation (i.e., in the configuration away from the pole 302), the rearward base wall 142 and rearward handle wall 144 reach abutment and further pivoting is precluded. The allowable amount of rotation and degree of separation between the subassemblies is variable and subject to change in contemplated configurations of the device.

As shown in FIGS. 9 through 13, the fishing pole assembly 300 is the external device to which the handle 10 for a fishing pole is coupled. The fishing pole assembly 300 comprises the fishing pole 302 and the reel 304. The fishing pole is, exemplary shown, a long cylindrical rod and such fishing poles are known to those of skill in the art. The disclosure is not limited to any particular type or configuration of fishing pole or fishing pole assembly, and a number of the same are configured and suitable for use herewith. The fishing pole further comprises first end 306 and second end 308. With reference to the pole coupling subassembly, the first end 306 of the fishing pole 302 is corresponds to the back end 34 of the pole receiver 20 when fully assembled.

Further, the reel comprises body 310, coupling clamp 312, and line 314. Line 314 runs from body 310 towards the send end 308 of the fishing pole 302 substantially parallel to fishing pole 302. The body 310 is known to those of skill in the arts as including both a place for fishing line to be reeled as well as a handle for facilitating the reeling in and out of the fishing line.

The coupling clamp 312 further comprises fastener openings that correspond to the reel coupling. In particular, the fastener openings are axially aligned with reel coupling 40 opening 41 and opening 43 of pole receiver 20. And the suitable fasteners can be extended therethrough so as to clamp the pole therebetween and also to secure the handle to the reel. It will be understood that there may be additional structures to fasten the reel to the pole that will likewise be understood to those of skill in the art. Some of such structures preclude the rotative movement of the reel relative to the pole. As such, when the handle assembly is coupled to the reel, the reel additionally precludes inadvertent axial relative rotation of the pole.

Assembly of the handle for a fishing pole 10 begins with the pole receiver 20 being aligned beneath the fishing pole 302 in such a way that reel fastener 24 and reel fastener 25 are axially aligned with the opening 41 and opening 43 of the reel coupling 40 and the fastener openings of the reel 304, respectively. The fasteners are fitted into said openings until such time that the pole receiver is coupled beneath the reel 304.

Next, the clamp member 22 is positioned above the pole receiver 20 with line 314 above the member. The fishing pole 302 fits within channel 30 along pole axis 45. Clamp fastener 26 and clamp fastener 27 are axially aligned with opening 47 and opening 49 of the clamp coupling 42 and the opening 62 and opening 63 of the receiver coupling 60. This coupling is complete when channel 30 is substantially filled by the fishing pole 302 so that the pole can be suitably clamped therebetween.

The handle member 72 of the handle assembly 14 placed along the fishing pole 302 in such a way that line 314 can be directed through the passage 115. The handle portion has the mating pivot opening 109 axially aligned with pivot opening 86 and pivot opening 96 of the base attachment portion in such a way that the forward limiting subassembly 130 and rearward limiting subassembly 140 are properly aligned with the appropriate walls of the pivot limiting structure. When aligned, the pivot axle 74 is fastened through the openings. The fastener is secured using bolts or another substantially equal locking tool to ensure the handle assembly 14 is coupled to the pole coupling subassembly 12.

In use, the user has the option of collapsing the handle member for storage or articulating the handle into the fully articulated configuration for use. To prepare the handle member for use, the handle member is pivoted until it reaches the fully articulated configuration. In that configuration, the fishing line extends through the lower passage 116 in a generally unobstructed manner with the upper passage generally free and separated from the line.

As desired, the user can grasp a number of different regions on the grasping portion, and preferably along the upper region thereof. That is, the user can grasp either one of the first side and the second side grasping region, or the upper transverse grasping region so as to achieve the desired grip and control over the pole, while the other hand is free to operate as in a conventional setting. The user can move and alter the hand among the upper region.

Once the user is done using the fishing pole assembly, the user may wish to collapse the handle member by rotating the handle member forward. In the configuration shown, as the handle member is rotated, the handle member eventually reaches the end of travel. In the configuration shown, when, or before, the end of travel is reached, the upper transverse grasping region pushes against the line.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A handle for a fishing pole assembly, the fishing pole assembly having a fishing pole with a first end and a second end, and a reel attachable to the fishing pole between the first and second end thereof, the handle comprising:
a pole coupling subassembly structurally configured attach to the fishing pole between the first end and the second end thereof, the pole coupling subassembly defining a pole axis;
a handle assembly having a base attachment portion fixed to the pole coupling subassembly and a handle member pivotably coupled to the base attachment portion about an axis that is substantially transverse to the pole axis.

2. The handle of claim 1 wherein the pole coupling subassembly further comprises a pole receiver defining a channel, and a clamp member defining an inner channel, cooperatively the channel and the inner channel defining a passage that corresponds to the fishing pole, wherein the pole receiver includes a clamp coupling and the clamp member includes a receiver coupling matingly engage each other, structurally configured to encircle the fishing pole.

3. The handle of claim 2 wherein the pole receiver and the clamp member are secured to each other through fasteners.

4. The handle of claim 3 wherein the pole receiver further includes a reel coupling, the reel coupling including a plurality of openings, structurally configured to matingly engage corresponding openings on a reel, structurally configured to receive fasteners extendable therethrough, to in turn, sandwich a fishing pole between therebetween.

5. The handle of claim 2 wherein the base attachment portion is fixed to the pole receiver proximate a first end thereof.

6. The handle of claim 5 wherein:
the base attachment portion comprises:
a first side tab having a first side pivot; and
a second side tab having a second side pivot, the second side tab spaced apart from the first side tab;
the handle member comprising a grasping portion defining a passage therethrough, the handle member including a mating pivot cooperatively alignable with the pivot to define the axis, and positionable between the first side tab and the second side tab.

7. The handle of claim 6 wherein the base attachment portion and the handle member comprise a monolithic member.

8. The handle of claim 6 further comprising a pivot axle extendable through the first side pivot, the second side pivot and the mating pivot.

9. The handle of claim 6 further comprising a pivot limiting structure to limit the forward and rearward pivoting of the handle member relative to the base attachment portion.

10. The handle of claim 9 wherein the pivot limiting structure further comprises:
a forward limiting subassembly that includes a forward base wall formed on the base attachment portion and a forward handle wall formed on the handle member, whereupon engagement therebetween precludes further forward pivoting; and
a rearward limiting subassembly that includes a rearward base wall formed on the base attachment portion and a rearward handle wall formed on the handle member, whereupon engagement therebetween precludes further rearward pivoting.

11. The handle of claim 6 wherein the grasping portion further defines a lower passage and an upper passage, the upper passage extending from the lower passage and including a first side grasping region and a second side grasping region opposite the first side grasping region, with an upper transverse grasping region extending between the first and second side grasping regions.

12. The handle of claim 11 wherein the lower region defines a lower passage which is narrower than the upper passage defined by the first and second side grasping regions and the upper transverse grasping region.

13. The handle of claim 12 wherein the handle member is symmetrical about the pole axis.

14. The handle of claim 13 wherein the first and second side grasping regions are substantially parallel to the pole axis.

15. The handle of claim 14 wherein the upper transverse grasping region is substantially perpendicular to the pole axis.

16. A fishing pole assembly and a handle, the fishing pole assembly comprising:
a fishing pole with a first end and a second end, and
a reel attachable to the fishing pole between the first and second end thereof, the reel structurally configured to receive a fishing line;
the handle comprising:
a pole coupling subassembly structurally configured attach to the fishing pole between the first end and the second end thereof, the pole coupling subassembly defining a pole axis;
a handle assembly having a base attachment portion fixed to the pole coupling subassembly and a handle member pivotably coupled to the base attachment portion about an axis that is substantially transverse to the pole axis.

17. The fishing pole assembly and handle of claim 16 wherein the pole coupling assembly is coupled to the reel and clamped to the fishing pole.

18. The fishing pole assembly and handle of claim 17 wherein the handle member defines a grasping portion that defines a passageway structurally configured to receive the fishing line therethrough and spaced apart from the fishing line when in an articulated configuration.

19. A method of installing a handle onto a fishing pole assembly comprising the steps of:
providing a fishing pole assembly including a fishing pole, a reel attached to the fishing pole between the first and second end thereof, the reel structurally configured to receive and retain a fishing line;
providing a pole coupling subassembly defining a pole axis;
positioning the fishing pole along the pole axis;
attaching the pole coupling subassembly to at least one of the fishing pole and the reel; and
pivotally attaching a handle member to the pole coupling subassembly, the handle structurally configured to pivot about a transverse axis that is substantially perpendicular to the pole axis.

20. The method of claim 19 wherein the step of pivotally attaching further comprises the step of:
limiting the pivoting of the handle member between a fully articulated configuration and a collapsed configuration.
